(19) United States
(12) Patent Application Publication
(10) Pub. No.: US 2006/0055273 A1
(43) Pub. Date: Mar. 16, 2006

(54) Screening assay based on rhe sod-3 promotor for the identification of compounds modulating akt or upstream regulators such as insulin igf-1 receptors

(76) Inventors: Javier Lasa Berasategui, Victoria (ES); Juan Jose Azurmendi Inchausti, Ormaiztegi (ES)

Correspondence Address: Javier Lasa Berasategui;Victor De La Serna 3-5, (parking), 28016 Madrid, Spain, ES

(21) Appl. No.: 10/542,806

(22) PCT Filed: Jun. 14, 2004
(86) PCT No.: PCT/ES04/00273

§ 371 Date: Jul. 20, 2005

(30) Foreign Application Priority Data
Jan. 30, 2003 (DE) 103-03-850.7

(51) Int. Cl. H02K 17/16; H02K 1/06; H02P 1/24

(52) U.S. Cl. 310/211; 310/217; 318/727

(57) ABSTRACT

A traction system for lifts, escalators, moving walkways and aerogenerators, provided with an asynchronous motor with squirrel cage rotor with low start-up current and high performance, and an asynchronous motor to work in said traction system, the power and operating speed of which are scaleable, varying input frequency and voltage so as to obtain between 2 and 2000 kW of power in different motor designs depending on their physical size and connection and the speed being proportional to the programmed frequency.

### OBJECT OF THE INVENTION

The object of this invention is a traction system for lifts, escalators, moving walkways and aerogenerators, of the kind that comprise activation by means of an electrical motor made up of a stator and a rotor and, in addition, in the case of lifts, an emergency system for cases of lack of power, the motor being an asynchronous motor with a squirrel cage rotor with low start-up current and high performance; as well as said asynchronous motor, the power and operating speed of which are scalable with variable frequency and input voltage so as to obtain between 2 and 2000 kW of power in different motor models depending on their physical size and their connection, the speed being proportional to the programmed frequency.

### BACKGROUND OF THE INVENTION

Due to the steady market demand for increasingly sophisticated and high-performance lift products, at present elevation products are being sought which are characterised by:

The elimination of the upper machine room

Improving the performance of the assembly in order to reduce energy consumption

Reducing the power of motors

Eliminating the use of oil in lifts so that they are in accordance with the ecological principals presently upheld

Increasing the range and capacity of lifts with small-sized systems

Increasing the operating speed of lifts with no cost increase, even with a single assembly, thus reducing part of current costs

Unification and standardisation of equipment with a decrease in production costs
Facilitating the rescue methods of lift passengers, and even making them function without mains power supply by the use of small batteries
Creating motors that are generators so as to even be able to produce energy and make it regenerative
Achieving a reduction of mains power consumption, with respect to that which is currently consumed, by 60%

All of the current disadvantages are eliminated by the use of the traction system for lifts, escalators, moving walkways and aerogenerators provided with asynchronous motor of the present invention.

For instance, in reference to the field of lifts, said system is distinguished from the one currently on the market in that it offers a wider field of application; for example, it can be used to transport from between 4 and 26 people; it does not require a machine room; all models use a mover; it does not require oil for its maintenance; it is high-performance with low installed power; it is characterised by its capacity for use at high speeds.

The system in question is mainly based on a motor assembly that consists of a solid, robust body that supplies movement to the lift cabin and to the counterweight. It is basically made up of a rotor and an asynchronous stator, a traction pulley, an electromechanical brake and a movement detection system provided with an emergency system.

The traction pulley is rigidly incorporated within the very axis of the rotor, with which it transmits the driving movement to the lift by way of the cable that loop around 180° to clasp its upper part. Over said motor pulley, a flat, cylindrical zone is situated where it directly activates the brake shoe and the braking movement force needed by the lift is executed. The motor pulley is of variable size depending on the number of cable slots for smaller or greater capacity of passengers, and varies between a minimum of three cables up to seven. Its diameter is always fixed at 320 mm.

The electromagnetic brake formed by electromagnet with over-excitement current and brake shoes on the aforementioned pulley plate functions by braking the lift.

The movement detector system comprises a digital encoder and is joined elastically to the rotor axis in order to transmit information on the rotor rotation speed. This provides the component with a high degree of safety and reliability.

Within the embodiment of the system object of the present invention is the positioning of the lift in an accessible place. For this purpose the machine is located at the upper part of the lift shaft, supported over two laminated profiles on the wall of the building itself, where the pressure effort is transmitted, appropriately isolated.

Similarly, the motor-lift conjoined system incorporates an electronic protocol of functioning to rescue people in two possible ways: a) Automatic rescue due to lack of exterior power; (b) Manual rescue with exterior voltage.

For this purpose, control cubicle and an emergency access cubicle are required, normally located at the last stop. Hence, 84 V (units of 12V) batteries are incorporated in order to make the motor function directly by way of a frequency splitter, and in order to open the door of the lift.

With system a), in case of a lack of exterior current, the lift directly accesses floor level and the doors open in order to free the trapped passengers, doing so automatically. The system tends to lower the lift but it will raise it in cases in which the static torque is insufficient for executing the operation, inverting the rotation direction. If it is sufficient, it goes directly down to the floor below. In both cases it ends up by stopping, its doors open and the rescue system is inactivated. If the emergency occurs at floor level itself, the doors are opened instantly.

With system b), in the case that there is an external current and in manual mode, the lift cabin movement is carried out since one of the safety contacts is inactivated. For this purpose it should be bridged and, under control, the lift cabin moved to floor level and the doors opened.

The system is provided with visual and acoustic detectors of the arrival of the lift cabin to floor level. Therefore, the rescue procedure is carried out electromechanically, in automatic or manual mode, in complete safety.

On the other hand, both lift apparatuses and escalators and moving walkways activated by electrical motors present specific problems, such as the large number of start-ups and shutdowns per unit of time, and cargo variation. Up to now, this problem has been solved through the use of geared motor groups.

In addition, the energy generators applied to wind-driven generators both for the start-up of the assembly and operating by way of the generator require a revolution multiplier.

The invention is related to traction systems activated by low-slippage and high-torque asynchronous motors, this activating being unusual up to the present in this field. The asynchronous motor is so-called because the rotating magnetic field generated by the stator is compensated by the one created by induction in the rotor with some delay in the rotation that brings about slippage against one another and which, in the motors built with the aforementioned technique, is of an approximate magnitude of 16% of the rotation speed of the magnetic field created by the stator in nominal conditions. In addition, the asynchronous motors of the aforementioned techniques have a high start-up intensity of approximately 1.5 to 3 times the nominal rating and use high current densities, normally of about 10 A/mm².

These drawbacks can be avoided by way of synchronous motors, although they also bring about disadvantages, such as the use of large permanent magnets, their high cost, problems related to their handling and their deterioration due to heating.

In order to overcome these drawbacks a proportional multipolar investigation has been carried out, that is, starting from an initial produced and functional size, other sizes have been developed in order to achieve greater power, always in a proportional manner, that is, scaled, from the initial prototype, from different motors powered by way of an electronic assembly with voltage input frequency splitter and diagrams have been drawn up of their functioning as a result of the variation of different parameters such as voltage and intensity values, wiring, frequency and number of poles.

As a result of this proportional multipolar investigation the asynchronous motor of the present invention has been obtained, which offers the following advantages:
a) The asynchronous motor starts up without peaking in intensity consumption.
b) It has a very low slippage, of approximately 8%.
c) High performance.
d) Low current density that does not surpass 6 A/mm², which guarantees a uniform and unsaturated magnetic field.
e) Low degree of heating, since in the electrical winding a 55° C. is rarely exceeded, with a high rhythm of 180 connections/hour and maximum output torque.
f) As a consequence of the above, a very long working life.

### BRIEF DESCRIPTION OF THE DRAWINGS

The disclosure provided below will be better understood with reference to the attached drawings in which:

FIG. 1 shows an expanded perspective view of the stator and the rotor without coiling or copper rods, respectively;

FIG. 2 shows a side view of the rotor where the arrangement of the copper bars and the squirrel cage rings are illustrated;

FIG. 3 shows a side view of the carcass of the asynchronous motor with a section separated in order to illustrate its construction better;

FIG. 4 shows a view of the X-X′ section of FIG. 3, where the shape of the stator and the carcass of the motor is seen;

FIG. 5 shows the characteristic torque-angular speed curve of the asynchronous motor of the invention;

FIG. 6 shows the characteristic intensity-angular speed curve of the asynchronous motor of the invention;

FIG. 7 shows the characteristic intensity-torque curve of the asynchronous motor of the invention; and

FIG. 8 shows the characteristic start-up-angular speed curve of a standard asynchronous motor or of a synchronous motor and of an asynchronous motor according to this invention.

### DETAILED DESCRIPTION OF A PREFERRED EMBODIMENT

The asynchronous motor of the invention is disclosed below, which is specified based on a preferred embodiment of the same for 2 to 20 kW of power used in lifts.

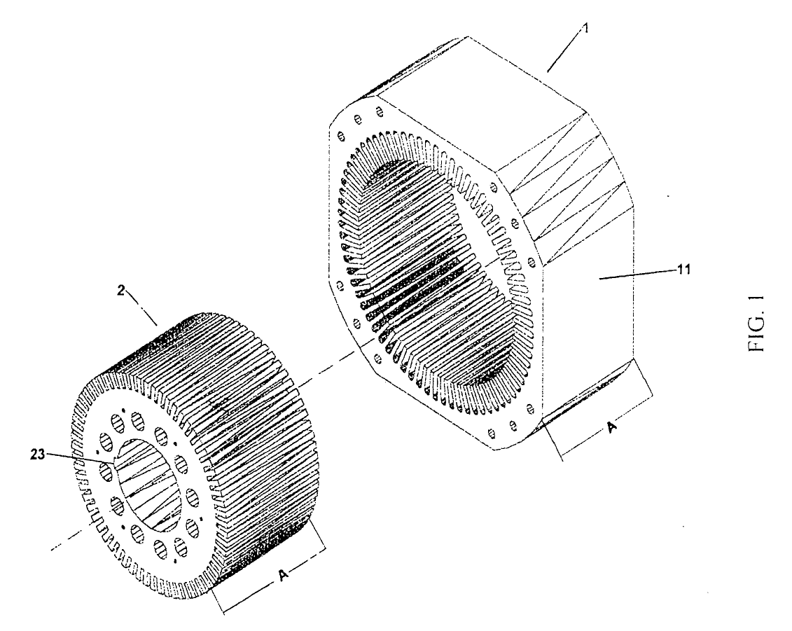

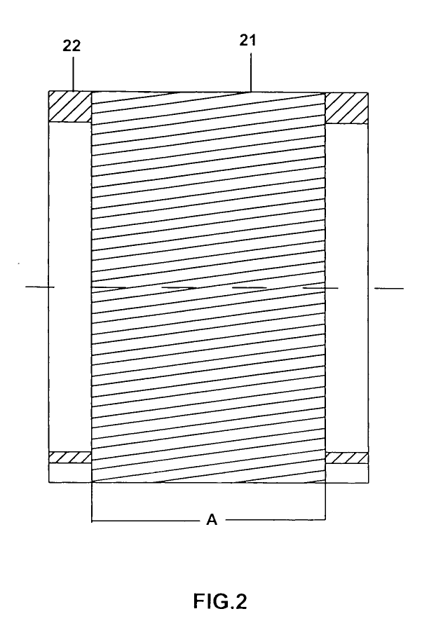

FIG. 1 illustrates an expanded perspective view of the stator 1 and of the rotor 2 of the asynchronous motor showing only the magnetic plates that they are composed of with the corresponding slots for inserting the coiling into stator 1, not shown, and the squirrel cage rods 21 and rings 22 in the rotor as can be seen in FIG. 2 that shows a side view of rotor 2.

The main characteristics of the asynchronous motor of the present invention with reference to its physical parameters are the following:

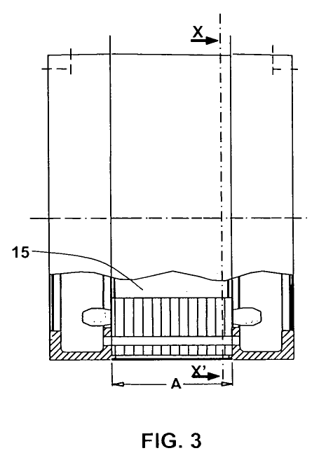

Short-circuited rotor 2 formed by the squirrel cage of copper rods with a number preferably between 54 and 76, and more preferably of 66 in the preferred embodiment. The number of rods of rotor 2 is proportional to the number of slots in stator 1 in an approximate proportion of 90% of the former with respect to the latter. The squirrel cage is made up of 21 copper rods with a 5×16 mm crossways section, which are inclined 8° with respect to the parents of the ideal cylinder formed by the exterior surface of the drum in squirrel cage. The squirrel cage is closed by way of two circular 22 copper rings, also with a 5×16 mm crossways section, the interior of which the 21 rods are welded to. The diameter of the rotor 2 in the preferred embodiment is of 280 mm. The thickness of the magnetic plate bundle that the rotor 2 forms, in which the copper squirrel cage is inserted, designated with the letter A in FIGS. 1 and 2, and which is equivalent to the magnetic plate thickness of the stator 1, also designated with the letter A in FIGS. 1 and 3, is of between 80 and 300 mm, depending on the power of the motor. The magnetic plates that make up the rotor 2 have the shape of a circular crown, their exterior surface being slotted in an axial direction for the insertion of the inclined 21 copper rods and with a single threading or necking in their interior so that in them a rib of the axis of the motor, not shown, and both elements rotate, the rotor 2 and the axis, solidariously.

In FIGS. 1, 3 and 4 the shape of the stator 1 is shown. The magnetic plates 11 that comprise it, have a square shape with cut off, arched corners, so that they can be inserted in a cast iron cylindrical carcass 12 that supports both the stator 1 and the rotor 2. The width and height of the magnetic plates 11 of the stator are of 385 mm, ±20%. The plates that form the stator 1 are joined together to form a bundle by way of 8 sticks that pass through the boreholes 13 made on the periphery of the plates with a quantity of 12 and that also affix it to the cast iron rings 12 that surround the stator 1. In the centre of the plates there is a circular gap that defines the interior surface of the stator 1 with slots 14 parallel to the axis of the circular gap. In the preferred embodiment the number of slots 14 is preferably between 60 and 84, and more preferably is 72, necessarily being a multiple of 12 in every case. The thickness of the bundle of plates of the stator 1 is, as mentioned earlier A with the limits that were indicated. The air gap 15 measures 0.4 mm±0.1 mm.

The physical consecution of the stator assembly, forming a single bundle of magnetic nucleus between two rings of cast iron, in order to absorb the reaction to the working torque of the motor, is carried out by way of passing screw in a number of around 8, which perforate all of the assembly from one end to the other, where they are stretched. The cast iron rings have an exterior diameter of 452 mm±20% in the preferred embodiment.

As regards the electrical characteristics of the asynchronous motor, it should be indicated that:

the stator 1 is multipolar with such a number of poles that in the preferred embodiment winding is carried out for 12 poles. The current density in both the stator 1 and the rotor 2 is very low and does not surpass 6 A/mm², which guarantees a uniform magnetic field and prevents saturation.

the asynchronous motor with the aforementioned characteristics has a very low slippage of around 8% with respect to the synchronous speed, which is a significant improvement over the figures of synchronous motors of the previous technique, the figure of which is around 16%. On the other hand, the fact that the air gap is of only 0.4 mm±1 mm, the low slippage and low current density used and other constructive and input characteristics make the asynchronous motor of the invention have high performance and low losses due to heating because it has been proven that in the stator coiling the temperature of 55° C. is not exceeded functioning in conditions of maximum output torque and with a high rhythm of connections of 180 per hour.

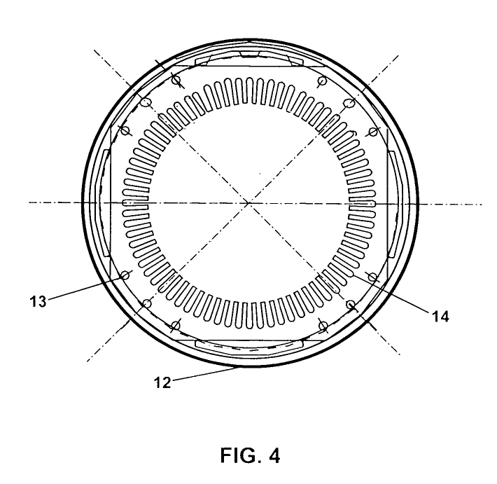

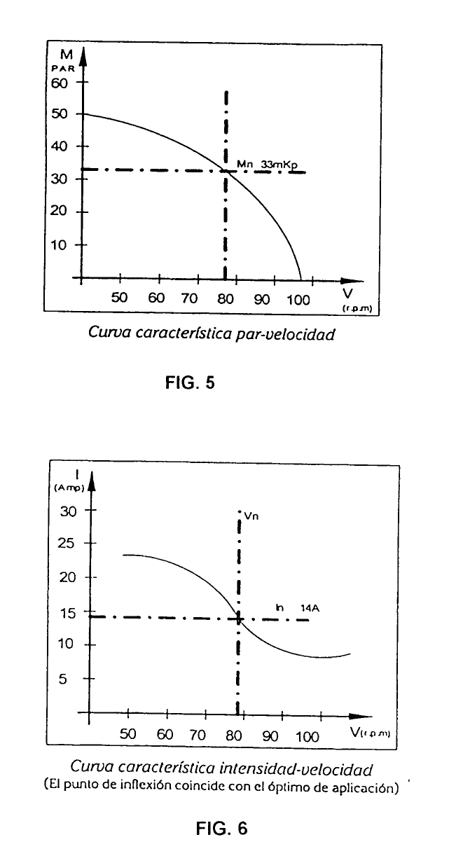

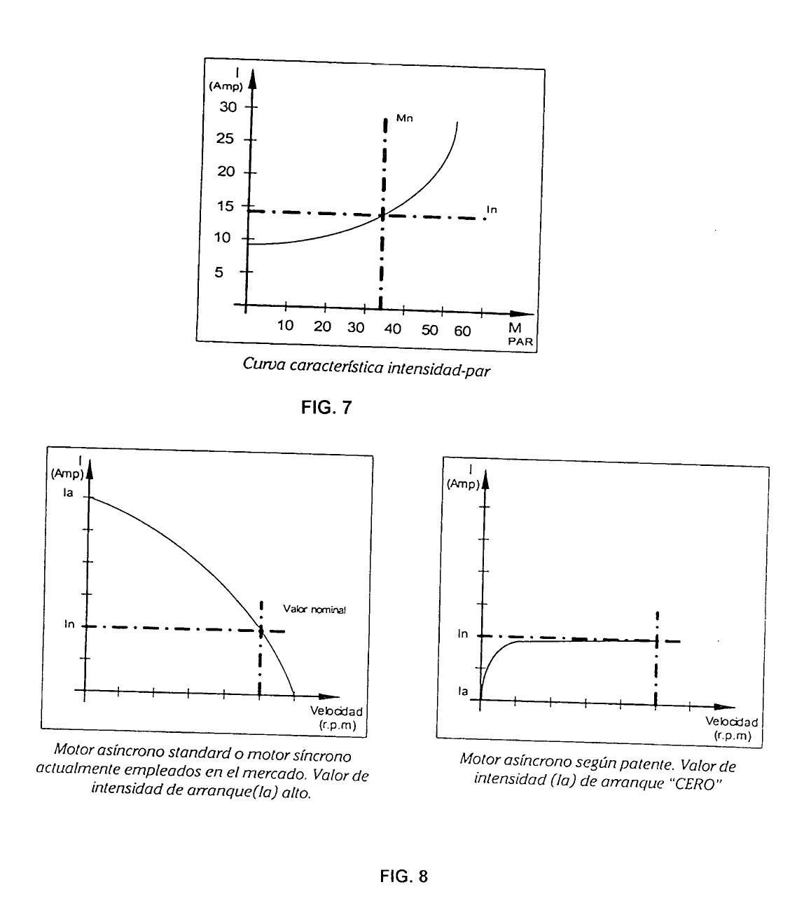

FIGS. 5, 6 and 7 show different characteristic curves of the functioning of the motor such as the torque-angular speed curve, intensity-angular speed curve and intensity-torque curve;

FIG. 8 shows the start-up intensity curves of a conventional asynchronous or synchronous motor currently in use, where one can observe the high value of Iₐ of the start-up intensity and how the intensity decreases to reach as low as the nominal rating Iₙ for that operating speed, that is, the intensity from start-up until the operating speed is a growing function of the angular speed of the motor, its initial value being zero and continuing to be always less than or equal to the nominal rating In at the aforementioned operating speed.

This characteristic represents and important advantage of the asynchronous motor of the invention because it eliminates the input line transients, but it especially increases the efficiency of the motor and prevents the need for special protection elements for the start-up/shutdown contact units or for the electronic circuits designed for this purpose. This characteristic is most useful in applications such as elevating apparatuses where such operations are carried out continuously.

The asynchronous motor of the invention is specifically designed for each application depending on the load and the rating speed, and with specific input in current and frequency. With other values applied, the motor does not work. In accordance with multipolar dimensioning and construction, the asynchronous motor does or does not work; it stops producing an unacceptable level of noise, having a high level of consumption and not having a working torque, and instead works perfectly with surprising results, since the motor powered with a frequency splitter can reach the desired speed in the same way as a synchronous motor of permanent magnets that is much more expensive, always offering speed control in closed loop by way of an encoder. Any decrease in speed due to asynchronism is compensated for electronically with a minimum frequency increase, thus reaching an equivalent speed to that of synchronism.

Furthermore, acting over the motor construction characteristics, such as the number of slots in the rotor and stator, stator coil, its physical dimensions and providing the resulting asynchronous motor with the adequate voltage and frequency, with the corresponding phase shift between adjoining poles in accordance with the number of said poles, results in obtaining two important advantages, the selection of both the nominal rotation speed within a wide margin and the motor output power, that make it possible to apply this motors to lifts, escalators and moving walkways with power from 2 kW to 20 kW, and to energy generators for aerogenerators for the start up of the equipment in generatory mode eliminating the usual multiplier component with power of up to 2000 kW, although for this latter power figure it is required to increase the diameter of the stator 1 to 2000 mm and the thickness A of the bundles of magnetic plates of the stator 1 and of the rotor 2 up to 1000 mm.

1. Traction system for lifts, escalators, moving walkways and aerogenerators, of the kind which comprise activation by way of electrical motor consisting of a stator and a rotor and, in the case of lifts, an emergency system for cases in which a lack of power occurs
characterised in that
the electrical motor is three-phase asynchronous with a first type of motor that is applied directly to lifts, escalators and moving walkways, eliminating the need for a standard geared motor, with an electrical current range of between a minimum of 2.2 kW and a maximum of 20 kW; and a second type of motor that is applied directly to aerogenerators, for the start-up of both the aerogenerator and the energy generator, eliminating the standard multiplier component, with an electrical current range of between a minimum of 20 kW and a maximum of 2000 kW;
in that
its intensity from start-up up to the operating speed is a growing function of the angular speed of the motor, its initial value being zero and always remaining less than or equal to the nominal rating at said operating speed;
and in that
once the speed and power necessary for each application is established, constructive mechanical and electrical parameters of the motor and its voltage and input frequency are determined.

2. A three-phase asynchronous motor for traction systems for lifts, escalators, moving walkways and aerogenerators, comprising a stator (1) and a rotor (2) each formed by a bundle of magnetic plates, the thickness of each of said bundles being equal, the bundle of magnetic plates of the stator (1), the shape of which is square with arched, cut off corners, having a central cylindrical gap, the periphery of which defines an interior surface where there are a plurality of axially arranged slots (14) for imbedding a coiling, and the bundle of magnetic plates of the rotor (2) being cylindrically-shaped with a central gap that is also cylindrical for said motor to pass through, and the exterior surface of said rotor being axially slotted for imbedding copper rods (21) that, welded at their ends to two rings (22), also of copper, form a squirrel cage,
characterised in that
said mechanical constructive parameters of the motor are:
in the first type of motor said square-shaped magnetic plates with cut off, arched corners that comprise the stator (1) have a width and a height of 385 mm±20%, while in the second type of motor this width and this height can reach up to 2000 mm±20%;
the quantity of said plurality of axial slots (14) of the stator is a number of between 60 and 84, and preferably 72, said number necessarily being a multiple of 12;
the thickness of said bundles of magnetic plates of the stator (1) and of the rotor (2) is of between 80 and 300 mm in the first type of motor, and up to 1000 mm in the second type of motor, depending on the power of the motor;
the air gap (15) or distance between said exterior surface of said rotor (2) and said interior surface of said cylindrical gap of said stator is of 0.4 mm±0.1 mm;
the diameter of said exterior surface of said rotor (2) is of 280 mm;
said plurality of axial slots of said rotor (1) is made up of a quantity of between 54 and 76 and is preferably of 66;
said number of axial slots of the rotor (2) is approximately 90% of said number of axial slots (14) of the stator (1);
said axial slots of the rotor (2) form an angle of 8° with the parents of an ideal cylinder formed by said squirrel cage;
said copper rods (21) and rings (22) that said squirrel cage forms have a crossways section of 5×16 mm.

3. A three-phase asynchronous motor in accordance with claim 2,
characterised in that
said electrical constructive parameters are:
the stator (1) is coiled with 12 poles;
in the stator (1) and in the rotor (2) the current density does not surpass 6 A/mm²;
the asynchronous motor has a slippage of approximately 8% with respect to the synchronous speed.

4. The asynchronous motor in accordance with claim 2
characterised in that
its intensity from start-up up to the operating speed is a growing function of the angular speed of the motor, its initial value being zero and always remaining at less than or equal the nominal intensity at said operating speed.

5. The asynchronous motor in accordance with claim 2
characterised in that
by way of the increase of the diameter of the stator (1) up to 2000 mm and the thickness A of the bundle of magnetic plate of the stator (1) and the rotor (2) up to 1000 mm and acting on the constructive characteristics of the motor and feeding the resulting asynchronous motor with the necessary voltage and frequency, with the corresponding phase shift between adjoining poles in accordance with the number of said poles, the selection of both the nominal rotation speed within a wide margin and the motor output power from 20 kW to 2000 kW, for its use in aerogenerators without the need for the standard multiplier component.
